(19) United States
(12) Patent Application Publication
(10) Pub. No.: US 2020/0040246 A1
(43) Pub. Date: Feb. 6, 2020

(54) COOLANT COMPOSITION

(71) Applicant: TOYOTA JIDOSHA KABUSHIKI KAISHA, Toyota-shi (JP)

(72) Inventors: Hiroyuki ARAI, Toyota-shi (JP); Yasuaki KODAMA, Seto-shi (JP); Masayuki NAGASAWA, Toyota-shi (JP); Tsutomu SAKAI, Osaka (JP); Hironori SHIRAISHI, Osaka (JP); Yasumi TAKAHASHI, Osaka (JP)

(21) Appl. No.: 16/502,257

(22) Filed: Jul. 3, 2019

(30) Foreign Application Priority Data
Aug. 1, 2018 (JP) 2018-145382

(51) Int. Cl. C09K 5/20; C09K 5/10

(52) U.S. Cl. CPC C09K 5/20; F01P 2003/001; C09K 5/10

(57) ABSTRACT

Provided is a coolant composition having not only excellent antifreeze properties and insulation properties but also improved cooling performance. The above coolant composition containing the following components: (A) a polyhydric alcohol; (B) water; (C) a compound having a functional group capable of forming a hydrogen bond with both component (A) and component (B); and (D) a nonionic surfactant, wherein the content ratio X (mol %) of component (C) to the sum of component (A) and component (C) in the coolant composition is in a range that satisfies the following: the freezing point of the coolant composition is equal to or lower than the freezing point of a solution consisting of components (A) and (B) containing component (B) at the same mass ratio as the mass ratio of component (B) to the coolant composition; and the freezing point of the coolant composition is equal to or lower than the freezing point of a solution consisting of components (C) and (B) containing component (B) at the same mass ratio as the mass ratio of component (B) to the coolant composition.

### CROSS REFERENCE TO RELATED APPLICATIONS

The present application claims priority from Japanese patent application JP 2018-145382 filed on Aug. 1, 2018, the content of which is hereby incorporated by reference into this application.

### BACKGROUND

### Technical Field

The present disclosure relates to a coolant composition and a method for producing the same.

### Background Art

Conventionally, various coolants have been known as coolants for cooling automobile engines and the like, and among them, water has been widely used because it has the highest cooling performance. However, pure water freezes at 0° C. or less. Therefore, when a coolant is exposed to a very low temperature environment as in an automobile, an aqueous solution of glycols such as ethylene glycol (EG) and propylene glycol (PG) is mainly used as a base. However, since glycols have a lower heat transfer coefficient than water, the coolant blending them decreases the heat transfer coefficient and cannot dissipate the heat generated during high load operation, resulting in the possibility such as boiling of the coolant, damage to a member, or thermal runaway in a battery. Therefore, a coolant capabling of achieving both the securing of the antifreeze properties and the improvement of the cooling performance has been required (for example, JP 2013-253190 A).

Another method for lowering the freezing temperature of a coolant is to use the molar freezing point depression by adding an ionized additive (converting to ions) such as inorganic salts, and in this case, the ionized additive increases the electrical conductivity of the coolant and thus cannot be used for a coolant in a fuel cell stack, a battery, an electric circuit board or the like which requires insulation properties, low electrical conductivity, and high electrical resistance. These applications have the concern that current is supplied through the liquid to cause leakage, short circuit between electrodes, and the like.

For use in a wide range of applications, the coolant having not only excellent antifreeze properties and insulation properties but also improved cooling performance has been required.

### SUMMARY

The present disclosure provides a coolant composition having not only excellent antifreeze properties and insulation properties but also improved cooling performance.

### Solution to Problem

The present inventors have found that the above object can be achieved by containing a specific amount of a compound, as a third component, having a functional group capable of forming a hydrogen bond with both water and a polyhydric alcohol in a coolant including water and a polyhydric alcohol and by further adding a nonionic surfactant, and have completed the present disclosure.

The present disclosure includes the following:

(1) a coolant composition comprising the following components:
(A) a polyhydric alcohol;
(B) water;
(C) a compound having a functional group capable of forming a hydrogen bond with both component (A) and component (B); and
(D) a nonionic surfactant,

wherein a content ratio X (mol %) of component (C) to the sum of component (A) and component (C) in the coolant composition is in a range that satisfies the following:

a freezing point of the coolant composition is equal to or lower than a freezing point of a solution consisting of components (A) and (B) containing component (B) at the same mass ratio as a mass ratio of component (B) to the coolant composition; and

the freezing point of the coolant composition is equal to or lower than a freezing point of a solution consisting of components (C) and (B) containing component (B) at the same mass ratio as the mass ratio of component (B) to the coolant composition.

(2) the coolant composition according to (1), wherein the functional group capable of forming a hydrogen bond with both component (A) and component (B) is at least one selected from the group consisting of a hydroxyl group, a carboxyl group, and an amino group.
(3) the coolant composition according to (1) or (2), wherein the polyhydric alcohol (A) is at least one selected from the group consisting of ethylene glycol and propylene glycol.
(4) the coolant composition according to any of (1) to (3), wherein component (C) is a tertiary alcohol.
(5) the coolant composition according to (4), wherein component (C) is at least one selected from the group consisting of tert-butanol and tert-amyl alcohol.
(6) the coolant composition according to any of (1) to (5), wherein the content ratio X is 15.0 to 45.0 mol %.
(7) the coolant composition according to any of (1) to (6), wherein an HLB value of the nonionic surfactant (D) is 12 to 20.
(8) the coolant composition according to any of (1) to (7), wherein a content of the water (B) is 45 to 75 parts by mass per 100 parts by mass of the coolant composition.
(9) the coolant composition according to any of (1) to (8), wherein an electrical conductivity is 10 μS/cm or less.
(10) a method for producing the coolant composition according to any of (1) to (9), including the step of:

determining the content ratio X (mol %) in the resulting coolant composition by measuring a freezing point of a solution containing components (A), (B), and (C) when the content ratio X (mol %) of component (C) to the sum of component (A) and component (C) is changed with the mass ratio of component (B) to the solution kept constant and finding a range of X wherein the above freezing point is equal to or lower than the freezing point of the solution at X=0 and equal to or lower than the freezing point of the solution at X=100.

### Advantageous Effects of Invention

According to the coolant composition of the present disclosure, the cooling performance can be improved while securing the antifreeze properties and the insulation properties, compared with the conventional coolant including water and a polyhydric alcohol.

### BRIEF DESCRIPTION OF THE DRAWINGS

FIG. 1 is a schematic diagram of the freezing point measuring device used in Examples;

FIG. 2 is a schematic diagram of the heat transfer coefficient measuring device used in Examples; and

FIG. 3 is a graph showing the relationship between TBA (tert-butanol) content ratio and freezing point in a coolant composition containing 60 parts by mass of water.

### DETAILED DESCRIPTION

The present disclosure relates to a coolant composition comprising the following components: (A) a polyhydric alcohol; (B) water; (C) a compound having a functional group capable of forming a hydrogen bond with both component (A) and component (B); and (D) a nonionic surfactant, wherein the content ratio X (mol %) of component (C) to the sum of component (A) and component (C) in the coolant composition is in a range that satisfies the following: the freezing point of the coolant composition is equal to or lower than the freezing point of a solution consisting of components (A) and (B) containing component (B) at the same mass ratio as the mass ratio of component (B) to the coolant composition; and the freezing point of the coolant composition is equal to or lower than the freezing point of a solution consisting of components (C) and (B) containing component (B) at the same mass ratio as the mass ratio of component (B) to the coolant composition (hereinafter, also referred to as the coolant composition of the present disclosure). The present inventors have found that the freezing point can be reduced by containing a specific amount of a compound, as a third component, having a functional group capable of forming a hydrogen bond with both water and a polyhydric alcohol in a coolant comprising water and a polyhydric alcohol and by further adding a nonionic surfactant, compared with two-component coolants of water/polyhydric alcohol and water/third component. As a result, even when the water content of the water/polyhydric alcohol coolant is increased, the heat transfer coefficient of the coolant can be increased while maintaining the freezing point. Since the surfactant added to improve the miscible state of the third component and effectively lower the freezing point is nonionic, the electrical conductivity of the coolant does not increase, allowing for the electrical conductivity of the coolant to be low and resulting in a high electrical resistance.

Water forms hydrogen bonds with water molecules, and nucleation (freezing) occurs when molecular assemblies called water clusters are arranged in an ice-like structure. In the case of an aqueous solution of ethylene glycol, which is a polyhydric alcohol, hydrogen bonds are formed between ethylene glycol and water and the structure of clusters is disturbed, thereby inhibiting nucleation and lowering the freezing point. Although not according to theory, it is considered that since the structure of the cluster is further disturbed by adding a compound (for example, TBA) having a functional group capable of forming a hydrogen bond with both water and a polyhydric alcohol as a third component, there is the content ratio X of the third component (the mole fraction of the third component to the sum of the polyhydric alcohol and the third component) at which the freezing point is minimized, and at this point, an eutectic point composition exists. For example, in Fukasawa, T.; Tominaga, Y.; and Wakisaka, A. J. Phys. Chem. A. 2004, 108, 59-63, in the TBA/water system, it is reported that the TBA concentration causes a portion of the water cluster (an aggregate formed by water molecules to be linked by hydrogen bonds) to be replaced with TBA and the water cluster to be destroyed. The coolant composition of the present disclosure contains the third component at a content in a range comprising the content ratio X of the third component corresponding to such a eutectic point composition and thus has excellent antifreeze properties and improved cooling performance.

The coolant composition of the present disclosure comprises a polyhydric alcohol as component (A). Examples of the polyhydric alcohol include at least one alcohol selected from the group consisting of dihydric alcohols and trihydric alcohols. The dihydric alcohol may consist of one selected from the group consisting of ethylene glycol, diethylene glycol, triethylene glycol, propylene glycol, 1,3-propanediol, 1,4-butanediol, 1,3-butanediol, 1,5-pentanediol, and hexylene glycol, or a mixture thereof. The trihydric alcohol may consist of one selected from the group consisting of glycerin, trimethylol ethane, trimethylol propane, 5-methyl-1,2,4-heptanetriol, and 1,2,6-hexanetriol, or a mixture thereof. Among these alcohols, from the view point of handling, price, and availability, ethylene glycol, propylene glycol, and 1,3-propanediol are in some embodiments.

The coolant composition of the present disclosure comprises water as component (B). As water, ion exchange water is in some embodiments. In the coolant composition of the present disclosure, the blending ratio of the polyhydric alcohol (A) and the water (B) is adjusted in consideration of the antifreeze properties in some embodiments.

The coolant composition of the present disclosure comprises a compound having a functional group capable of forming a hydrogen bond with both component (A) and component (B) as component (C). The compound has at least one selected from the group consisting of a hydroxyl group, a carboxyl group, and an amino group as a functional group capable of forming a hydrogen bond with both component (A) and component (B) in some embodiments. From the viewpoint of improving the solubility in component (A) and component (B) and keeping the electrical conductivity low, component (C) is a tertiary alcohol having 4 or more and 6 or less carbon atoms in some embodiments, the examples includes tert-butanol (2-methyl-2-propanol), tert-amyl alcohol (2-methyl-2-butanol), 2-methyl-2-pentanol, 3-methyl-3-pentanol, 2,3-dimethyl-2-butanol, and the like, and among them, tert-butanol and tert-amyl alcohol are in some embodiments. The above compounds can also be used in combination in the coolant composition of the present disclosure.

The coolant composition of the present disclosure comprises a nonionic surfactant as component (D). The nonionic surfactant may consist of one selected from the group consisting of polyoxyethylene alkyl ether, polyoxyethylene octyldodecyl ether, polyoxyethylene myristyl ether, polyoxypropylene alkyl ether, polyoxyethylene polyoxypropylene block polymer, polyoxyethylene alkylphenyl ether, polyoxypropylene alkyl phenyl ether, polyoxyethylene distyrenated phenyl ether, sorbitan fatty acid ester, sucrose fatty acid ester, polyoxyethylene sorbitan fatty acid ester, polyoxypropylene sorbitan fatty acid ester, polyoxyethylene fatty acid ester, and polyoxypropylene fatty acid ester, or a mixture thereof. From the viewpoint of improving the miscibility with component (A), component (B), and component (C), HLB value of the nonionic surfactant (D) is 12 to 20 in some embodiments, and 16 to 19 in other embodiments.

In the coolant composition of the present disclosure, the content ratio X (mol %) of component (C) to the sum of component (A) and component (C) is in a range that satisfies the following: the freezing point of the coolant composition is equal to or lower than the freezing point of the solution comprising components (A) and (B) containing component (B) at the same mass ratio as the mass ratio of component (B) to the coolant composition; and the freezing point of the coolant composition is equal to or lower than the freezing point of the solution comprising components (C) and (B) containing component (B) at the same mass ratio as the mass ratio of component (B) to the coolant composition. Since the coolant composition of the present disclosure comprises component (C) at a content ratio X within the range satisfying the above requirements, the freezing point is sufficiently reduced. The freezing point of the coolant composition of the present disclosure is 0.5° C. or more lower in some embodiments and 1.0° C. or more in other embodiments lower than the freezing point of the solution consisting of components (A) and (B) containing component (B) in the same mass ratio as the mass ratio of component (B) to the coolant composition. The freezing point of the coolant composition of the present disclosure is 0.5° C. or more lower in some embodiments and 1.0° C. or more in other embodiments lower than the freezing point of the solution consisting of components (C) and (B) containing component (B) in the same mass ratio as the mass ratio of component (B) to the coolant composition. Such a range of the content ratio X (mol %) can be determined by measuring the freezing point of a solution containing components (A), (B), and (C) when the content ratio X (mol %) of component (C) to the sum of component (A) and component (C) is changed with the mass ratio of component (B) to the solution kept constant and finding a range of X wherein the above freezing point is equal to or lower than the freezing point of the solution at X=0 and is equal to or lower than the freezing point of the solution at X=100. The range of X can be determined, for example, by plotting the measured values of the freezing point against the content ratio X and by creating a curve connecting the plots.

From the viewpoint of sufficiently reducing the freezing point, the content ratio X (mol %) of component (C) to the sum of component (A) and component (C) is 15.0 to 45.0 mol % in some embodiments and 20.0 to 42.0 mol % in other embodiments.

In 100 parts by mass of the coolant composition of the present disclosure, from the viewpoint of securing the antifreeze properties, the content of the polyhydric alcohol (A) is 10 to 50 parts by mass in some embodiments and 20 to 30 parts by mass in other embodiments.

In 100 parts by mass of the coolant composition of the present disclosure, from the viewpoint of securing the cooling performance, the content of the water (B) is 45 to 75 parts by mass in some embodiments and 55 to 65 parts by mass in other embodiments.

In 100 parts by mass of the coolant composition of the present disclosure, from the viewpoint of sufficiently lowering the freezing point, the content of the compound (C) having a functional group capable of forming a hydrogen bond with both component (A) and component (B) is 5.0 to 30 parts by mass in some embodiments and 10 to 20 parts by mass in other embodiments.

In 100 parts by mass of the coolant composition of the present disclosure, from the viewpoint of improving the miscible state of component (C), the content of the nonionic surfactant (D) is 0.5 to 10 parts by mass in some embodiments and 1.0 to 5.0 parts by mass in other embodiments. From the same viewpoint, the content of component (D) is 5 to 20% by mass based on component (C) in some embodiments.

In the coolant composition of the present disclosure, other additives can be blended in addition to components (A) to (D) according to the application as long as the effects of the present disclosure are not impaired.

For example, when used for engine coolant, the coolant composition of the present disclosure comprises at least one or more rust inhibitors in the range that does not impair the effects of the present disclosure in order to effectively suppress the corrosion of metals used in the engine coolant path. Examples of the rust inhibitor include any of one of phosphoric acid and/or salt thereof, aliphatic carboxylic acid and/or salt thereof, aromatic carboxylic acid and/or salt thereof, triazoles, thiazoles, silicates, nitrate, nitrite, borate, molybdate, and amine salts, or a mixture thereof.

For example, the coolant composition of the present disclosure can comprise at least one or more pH adjusting agents in a range that does not impair the effects of the present disclosure in order to prevent metal corrosion. Examples of the pH adjusting agent include any of one or more mixtures of sodium hydroxide, potassium hydroxide, and lithium hydroxide. The pH of the coolant composition of the present disclosure at 25° C. is 6 or more in some embodiments, 7 or more in other embodiments, and 10 or less in some embodiments, 9 or less in other embodiments.

For example, the coolant composition of the present disclosure can be suitably added with an antifoamer, a coloring agent, a dye, a dispersing agent, or a bitter taste agent in the range which does not impair the effect of the present disclosure.

The total amount of the above other additives blended is usually 10 parts by mass or less, 5 parts by mass or less in some embodiments, per 100 parts by mass of the composition.

From the viewpoint of securing the antifreeze properties, the coolant composition of the present disclosure can have a freezing point or less or less than freezing point of a polyhydric alcohol aqueous solution (for example, ethylene glycol aqueous solution) comprising water with the same content, and for example, the freezing point of the coolant composition is −15 to −45° C. in some embodiments. The freezing point can be measured by the method described in the following “1-1. Measurement of freezing point”.

From the viewpoint of securing the insulation properties, the electrical conductivity of the coolant composition of the present disclosure is 10 μS/cm or less in some embodiments and 5 μS/cm or less in other embodiments. The electrical conductivity can be measured by the method described in the following “1-2. Measurement of electrical conductivity”.

From the viewpoint of securing the cooling performance, the coolant composition of the present disclosure can have a heat transfer coefficient higher than that of a polyhydric alcohol aqueous solution having the same freezing point (for example, an ethylene glycol aqueous solution), and for example, 580 W/m²·° C. or more is in some embodiments. The heat transfer coefficient can be measured by the method described in the following “1-3. Measurement of heat transfer coefficient”.

The present disclosure also relates to a method for producing a coolant composition containing components (A), (B), (C), and (D) (hereinafter also referred to as the producing method of the present disclosure). The producing method of the present disclosure is suitable for the producing of the coolant composition of the present disclosure. The producing method of the present disclosure comprises the step (a) of determining the content ratio X (mol %) in the resulting coolant composition by measuring the freezing point of a solution containing components (A), (B), and (C) when the content ratio X (mol %) of component (C) to the sum of component (A) and component (C) is changed with the mass ratio of component (B) to the solution kept constant and finding a range of X wherein the above freezing point is equal to or lower than the freezing point of the solution at X=0 and equal to or lower than the freezing point of the solution at X=100. It is possible to obtain a coolant composition having a sufficiently low freezing point and excellent antifreeze properties by containing component (A) and component (C) within the range of the content ratio X determined by the step and setting the mass ratio of component (B) to the coolant composition to be a constant value or near a constant value in the step. Such a range of X can be determined, for example, by plotting the measured values of the freezing point against the content ratio X and by creating a curve connecting the plots. Some embodiments of the producing method of the present disclosure are those cited above for the coolant composition of the present disclosure, unless specifically stated otherwise.

The coolant composition of the present disclosure may further comprise the step (b) of adjusting the content of water which is component (B). Here, “adjusting the content of water” means to increase or decrease the content of water in order to bring the freezing point, the electrical conductivity, and/or the heat transfer coefficient of the coolant composition to a desired value. For example, in order to increase the heat transfer coefficient, it is conceivable to increase the water content.

In the producing method of the present disclosure, a method of mixing components (A) to (D) and optionally other additives is not particularly limited as long as the effects of the present disclosure can be obtained, and a common method for producing a coolant composition can be used.

The coolant composition of the present disclosure can be applied to an engine, an inverter device, a fuel cell, a battery, an electronic substrate and the like, regardless of its application as long as it is used for cooling.

Hereinafter, the present disclosure will be described in more detail using Examples, but the present disclosure is not limited to these Examples.

### EXAMPLES

### <1. Evaluation Test> the Evaluation Test of the Coolant Composition was Conducted as Follows

<1-1. Measurement of Freezing Point>

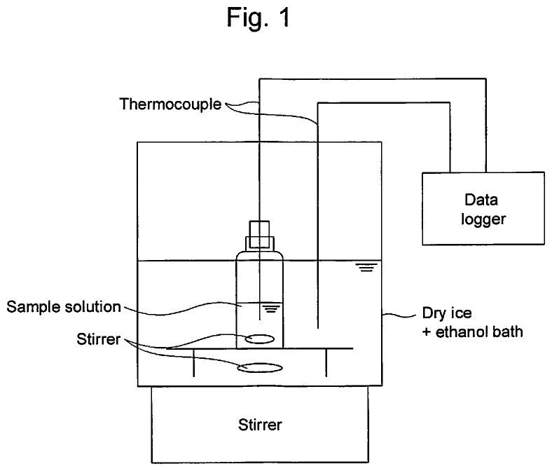

The freezing point measuring device shown in FIG. 1 was used.

A glass container containing 20 g of the sample was placed in an ethanol bath kept at −40° C. with dry ice, and a thermocouple was inserted near the center of the sample and then a freezing point was determined from a cooling curve obtained by recording using a data logger. The freezing point was taken as the maximum value of the cooling curve after release of the subcooling.

<1-2. Measurement of Electrical Conductivity>

Measurement was performed by the following procedures.

(1) 5% by mass of double ion exchange resin Amberlite MB-1 (manufactured by Organo Corporation) was added to the sample, and the mixture was stirred for about 1 hour with a stirrer.
(2) After standing for 12 hours, the resin was removed by filtration through a teflon mesh.
(3) The electrical conductivity at 25° C. was measured using a conductivity meter (CON2700 manufactured by EUTECH INSTRUMENTS) and a sensor (CONSEN 9201 D).

<1-3. Measurement of Heat Transfer Coefficient>

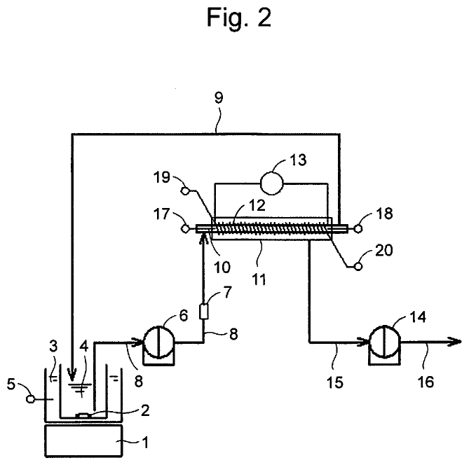

The heat transfer coefficient measuring device shown in FIG. 2 was used.

The adiabatic part of the heat transfer measurement pipe (heat transfer tube 10, heat transfer outer pipe 11, and electric heater 12) was vacuum-insulated by the vacuum pump 14 and thermally insulated. The sample and the stirrer 2 were placed in the measurement coolant tank 4 and placed in the warm water tank 3. The rotational speed of the coolant transfer pump 6 was adjusted so that the coolant flow meter 7 was 0.20 L/min, and the liquid was fed. Stirring heating device 1 and electric heater 12 (output: 53 to 54 W) were adjusted so that sample inlet temperature t1 might be 70° C. The sample inlet temperature t1 and outlet temperature t2, the outer inlet surface temperature T1 (inlet heater temperature) and the outer outlet surface temperature T2 (outlet heater temperature) of the heat transfer tube 10 were recorded with a data logger, the heat transfer coefficient U was calculated as follows from the average value for 60 minutes from 90 minutes to 150 minutes in which the temperature conditions became stable.

When the sample inlet temperature is t1 and the outlet temperature t2, the outer inlet surface temperature T1 (inlet heater temperature) and the outer outlet surface temperature T2 (outlet heater temperature) of the heat transfer tube 10, the logarithmic average temperature difference [° C.] is represented by the following equation (1):

Δlm={(T1−t1)−(T2−t2)}/ln {(T1−t1)/(T2−t2)} (1)

When the heat transfer area is A [m²] in the heat transfer tube 10 and the heat quantity of the electric heater 12 (power consumption of the electric heater power supply 13) Q [W], the heat transfer coefficient U [W/m²·° C.] of the sample is represented by the following equation (2). Since the outer tube of the electric heater 12 was thermally insulated by vacuum degassing, the amount of heat radiated can be ignored.

U=Q/(A×Δlm) (2)

### 2. Preparation of Coolant Composition

### Reference Examples 1 to 9

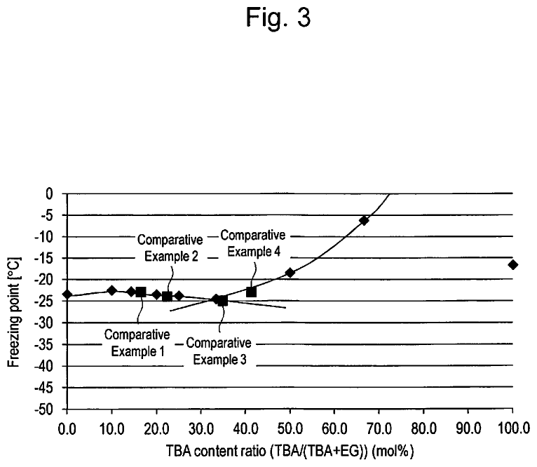

The materials of the formulations shown in Table 1 below were added, stirred and mixed to prepare a coolant composition. The coolant composition of Reference Examples 1 to 9 had 60 parts by mass of water with the balance being 40 parts by mass as ethylene glycol (EG) and tert-butanol (TBA) per 100 parts by mass of the coolant composition, and the TBA content ratio (TBA/(TBA+EG)) (mol %) was changed. Table 1 and FIG. 3 show the relationship between the TBA content ratio of the coolant composition and the freezing point (measured values) in Reference Examples 1-9.

TABLE 1

| | | Reference | Reference | Reference | Reference | Reference | Reference | Reference | Reference | Reference |
|---|---|---|---|---|---|---|---|---|---|---|
| | | Example | Example | Example | Example | Example | Example | Example | Example | Example |
| | | 1 | 2 | 3 | 4 | 5 | 6 | 7 | 8 | 9 |
| Composition | TBA | 0.00 | 4.69 | 6.64 | 9.20 | 11.39 | 14.95 | 21.77 | 28.19 | 40.00 |
| (parts by mass) | EG | 40.00 | 35.31 | 33.36 | 30.80 | 28.61 | 25.05 | 18.23 | 11.81 | 0.00 |
| | Water | 60 | 60 | 60 | 60 | 60 | 60 | 60 | 60 | 60 |
| Additional | TBA(74.12 g/mol) | 0.000 | 0.063 | 0.090 | 0.124 | 0.154 | 0.202 | 0.294 | 0.380 | 0.540 |
| amount (mol) | EG(62.068 g/mol) | 0.644 | 0.569 | 0.537 | 0.496 | 0.461 | 0.404 | 0.294 | 0.190 | 0.000 |

| | | | | | | | | | |
|---|---|---|---|---|---|---|---|---|---|
| TBA content ratio (mol %) (TBA/ | 0.00 | 10.0 | 14.3 | 20.0 | 25.0 | 33.3 | 50.0 | 66.7 | 100.0 |
| (TBA + EG)) | | | | | | | | | |
| Freezing point ° C. | −23.4 | −22.5 | −22.8 | −23.5 | −23.8 | −24.5 | −18.5 | −6.2 | −16.73 |

TBA: Tert-Butanol (manufactured by Nacalai Tesque, Inc.)
EG: Ethylene glycol (manufactured by Nacalai Tesque, Inc.)

From Table 1 and FIG. 3, there is a TBA content ratio having a freezing point lower than that of the two-component coolant composition of water/EG (Reference Example 1) and water/TBA (Reference Example 9) (Reference Examples 4-6). The TBA content ratio in Reference Example 6 having the lowest freezing point was 33.3 mol % (near the eutectic composition).

### Examples 1 to 4

The materials of the formulations shown in Table 2 below were added, stirred and mixed to prepare a coolant composition. The coolant composition in Examples 1 to 4 was 60 parts by mass of water with the balance being 40 parts by mass as ethylene glycol (EG), tert-butanol (TBA), and Newcol-2399-S (manufactured by NIPPON NYUKAZAI CO., LTD.), per 100 parts by mass of the coolant composition, and the TBA content ratio (TBA/(TBA+EG)) (mol %) was changed. The content of a nonionic surfactant is 10% by mass based on TBA.

### Examples 5 to 8

The materials of the formulations shown in Table 2 below were added, stirred and mixed to prepare a coolant composition. The coolant composition in Examples 5 to 8 had 60 parts by mass of water with the balance being 40 parts by mass as ethylene glycol (EG), tert-butanol (TBA), and a nonionic surfactant per 100 parts by mass of the coolant composition, and the TBA content ratio (TBA/(TBA+EG)) was 34.8 mol %; and the HLB value of the nonionic surfactant was changed. The content of a nonionic surfactant is 10% by mass based on TBA.

### Examples 9 to 11

The materials of the formulations shown in Table 2 below were added, stirred and mixed to prepare a coolant composition. In the coolant composition in Examples 9 to 11, the content of water in the coolant composition in Example 7 was changed in the vicinity of 60 parts by mass per 100 parts by mass of the coolant composition. The content of a nonionic surfactant is 10% by mass based on TBA.

Table 2 shows the freezing point, heat transfer coefficient, and electrical conductivity of the coolant composition in Examples 1 to 11.

TABLE 2

| | | | Exam- | Exam- | Exam- | Exam- | Exam- | Exam- | Exam- | Exam- | Exam- | Exam- | Exam- |
|---|---|---|---|---|---|---|---|---|---|---|---|---|---|
| | | | ple 1 | ple 2 | ple 3 | ple 4 | ple 5 | ple 6 | ple 7 | ple 8 | ple 9 | ple 10 | ple 11 |
| Composition | TBA | | 7.5 | 10 | 15 | 17.5 | 15 | 15 | 15 | 15 | 15 | 16 | 15 |
| (parts by | EG | | 31.75 | 29 | 23.5 | 20.75 | 23.5 | 23.5 | 23.5 | 23.5 | 24.5 | 24.4 | 26.5 |
| mass) | Water | | 60 | 60 | 60 | 60 | 60 | 60 | 60 | 60 | 59 | 58 | 57 |
| | Surfac- | Newcol-2399-S | 0.75 | 1 | 1.5 | 1.75 | — | — | — | — | — | — | — |
| | tant | Emargen 707 | — | — | — | — | 1.5 | — | — | — | — | — | — |
| | | Emargen 2020G-HA | — | — | — | — | — | 1.5 | — | — | — | — | — |
| | | Emargen A-500 | — | — | — | — | — | — | 1.5 | — | 1.5 | 1.6 | 1.5 |
| | | Emargen 4085 | — | — | — | — | — | — | — | 1.5 | — | — | — |

| | | | | | | | | | | | | |
|---|---|---|---|---|---|---|---|---|---|---|---|---|
| Additional | TBA(74.12 g/mol) | 0.101 | 0.135 | 0.202 | 0.236 | 0.202 | 0.202 | 0.202 | 0.202 | 0.202 | 0.216 | 0.202 |
| amount | EG(62.068 g/mol) | 0.512 | 0.467 | 0.379 | 0.334 | 0.379 | 0.379 | 0.379 | 0.379 | 0.395 | 0.393 | 0.427 |
| (mol) | | | | | | | | | | | | |

| | | | | | | | | | | | |
|---|---|---|---|---|---|---|---|---|---|---|---|
| TBA content ratio (mol %) (TBA/(TBA + | 16.5 | 22.4 | 34.8 | 41.4 | 34.8 | 34.8 | 34.8 | 34.8 | 33.9 | 35.4 | 32.2 |
| EG)) | | | | | | | | | | | |
| Freezing point ° C. | −25 | −28 | −33 | −29 | −25 | −28 | −34 | −26 | −36 | −36 | −38 |
| Heat transfer coefficient W/m² · ° C. | — | — | 613 | — | — | — | 608 | — | 622 | — | — |
| Electrical conductivity μS/cm | — | — | — | — | — | — | — | — | 1.07 | — | — |

TBA: Tert-Butanol (manufactured by Nacalai Tesque, Inc.)
EG: Ethylene glycol (manufactured by Nacalai Tesque, Inc.)
Newcol-2399-S (manufactured by NIPPON NYUKAZAI CO., LTD.) Polyoxyethylene alkyl ether HLB value 19.2
Emargen 707 (manufactured by Kao Corporation.) Polyoxyethylene alkyl ether HLB value 12.1
Emargen 2020G-HA (manufactured by Kao Corporation.) Polyoxyethylene octyldodecyl ether HLB value 15
Emargen A-500 (manufactured by Kao Corporation.) Polyoxyethylene distyrenated phenyl ether HLB value 18
Emargen 4085 (manufactured by Kao Corporation.) Polyoxyethylene myristyl ether HLB value 18.9

### Comparative Examples 1 to 4

The coolant composition having a TBA content ratio corresponding to the coolant composition in each of Examples 1 to 4 and comprising no surfactant was taken as each of Comparative Examples 1 to 4. The freezing point of the coolant composition in Comparative Examples 1 to 4 is a value read from a curve connecting the plots shown in FIG. 3 (Table 3 and FIG. 3).

### Comparative Examples 5 to 8

The materials of the formulations shown in Table 3 below were added, stirred and mixed to prepare a coolant composition. The coolant composition (ethylene glycol aqueous solution) in Comparative Examples 5 to 8 comprises water and ethylene glycol (EG) in various proportions per 100 parts by mass of the coolant composition.

Table 3 shows the freezing point (reading value) of the coolant composition in Comparative Examples 1 to 4, the freezing point (measured values) and the heat transfer coefficient of the coolant composition in Comparative Examples 5 to 8.

TABLE 3

| | | | Compara- | Compara- | Compara- | Compara- | Compara- | Compara- | Compara- | Compara- |
|---|---|---|---|---|---|---|---|---|---|---|
| | | | tive Ex- | tive Ex- | tive Ex- | tive Ex- | tive Ex- | tive Ex- | tive Ex- | tive Ex- |
| | | | ample 1 | ample 2 | ample 3 | ample 4 | ample 5 | ample 6 | ample 7 | ample 8 |
| Composition | TBA | | 7.6 | 10.3 | 15.6 | 18.3 | — | — | — | — |
| (parts by | EG | | 32.4 | 29.7 | 24.4 | 21.7 | 52.7 | 40 | 30 | 0 |
| mass) | Water | | 60 | 60 | 60 | 60 | 47.3 | 60 | 70 | 100 |
| | Surfac- | Newcol-2399-S | — | — | — | — | — | — | — | — |
| | tant | Emargen 707 | — | — | — | — | — | — | — | — |
| | | Emargen 2020G-HA | — | — | — | — | — | — | — | — |
| | | Emargen A-500 | — | — | — | — | — | — | — | — |
| | | Emargen 4085 | — | — | — | — | — | — | — | — |

| | | | | | | | | | |
|---|---|---|---|---|---|---|---|---|---|
| Additional | TBA(74.12 g/mol) | 0.103 | 0.138 | 0.210 | 0.247 | — | — | — | — |
| amount (mol) | EG(62.068 g/mol) | 0.521 | 0.479 | 0.393 | 0.350 | — | — | — | — |

| | | | | | | | | |
|---|---|---|---|---|---|---|---|---|
| TBA content ratio (mol %) (TBA/(TBA + EG)) | 16.5% | 22.4% | 34.8% | 41.4% | — | — | — | — |
| Freezing point ° C. | −23 | −24 | −25 | −23 | −40 | −24 | −15 | 0 |
| Heat transfer coefficient W/m² · ° C. | — | — | — | — | 580 | 605 | 635 | 752 |
| Electrical conductivity μS/cm | — | — | — | — | — | — | — | — |

TBA: Tert-Butanol (manufactured by Nacalai Tesque, Inc.)
EG: Ethylene glycol (manufactured by Nacalai Tesque, Inc.)

Tables 2 and 3 show that comparing the coolant composition in each of Examples 1 to 4 with the coolant composition in each of Comparative Examples 1 to 4, the addition of a nonionic surfactant to a coolant composition having a TBA content ratio near the eutectic composition can further lower the freezing point. Further, Examples 5 to 8 show that the freezing point can be further lowered by adjusting the HLB value of the nonionic surfactant. Examples 9 to 11 show that the freezing point can be further lowered by adjusting the water content. Comparison of the coolant composition in Example 9 with the coolant composition in Comparative Example 5 shows that the coolant composition in Example 9 can contain a large amount of water at the same freezing point, and thus the heat transfer coefficient is excellent, and thereby the cooling performance is improved while securing the antifreeze properties. In addition, comparison of the coolant composition in Example 9 with the coolant composition in Comparative Example 6 shows that the coolant composition in Example 9 has a lower freezing point at the same content of water and improved antifreeze properties.

### INDUSTRIAL APPLICABILITY

The coolant composition of the present disclosure is suitably used for cooling an engine, an inverter device, a fuel cell, a battery, an electronic substrate, and the like.

All publications, patent and patent applications cited herein are incorporated herein by reference in their entirety.

### DESCRIPTION OF SYMBOLS

1 Stirring heating device
2 Stirrer
3 Warm water tank
4 Measurement coolant tank
5 Warm water tank thermometer
6 Coolant transfer pump
7 Coolant flow meter
8 Coolant supply line
9 Coolant return line
10 Heat transfer tube
11 Heat transfer outer tube
12 Electric heater
13 Electric heater power supply
14 Vacuum pump
15 Vacuum line of heat transfer outer tube
16 Exhaust line
17 Thermocouple for measuring sample inlet temperature
18 Thermocouple for measuring sample outlet temperature
19 Thermocouple for measuring outer inlet surface temperature of heat transfer tube
20 Thermocouple for measuring outer outlet surface temperature of heat transfer tube

What is claimed is:

1. A coolant composition comprising the following components:
(A) a polyhydric alcohol;
(B) water;
(C) a compound having a functional group capable of forming a hydrogen bond with both component (A) and component (B); and
(D) a nonionic surfactant,
wherein a content ratio X (mol %) of component (C) to the sum of component (A) and component (C) in the coolant composition is in a range that satisfies the following:
a freezing point of the coolant composition is equal to or lower than a freezing point of a solution consisting of components (A) and (B) containing component (B) at the same mass ratio as a mass ratio of component (B) to the coolant composition; and
the freezing point of the coolant composition is equal to or lower than a freezing point of a solution consisting of components (C) and (B) containing component (B) at the same mass ratio as the mass ratio of component (B) to the coolant composition.

2. The coolant composition according to claim 1, wherein the functional group capable of forming a hydrogen bond with both component (A) and component (B) is at least one selected from the group consisting of a hydroxyl group, a carboxyl group, and an amino group.

3. The coolant composition according to claim 1, wherein the polyhydric alcohol (A) is at least one selected from the group consisting of ethylene glycol and propylene glycol.

4. The coolant composition according to claim 1, wherein component (C) is a tertiary alcohol.

5. The coolant composition according to claim 4, wherein component (C) is at least one selected from the group consisting of tert-butanol and tert-amyl alcohol.

6. The coolant composition according to claim 1, wherein the content ratio X is 15.0 to 45.0 mol %.

7. The coolant composition according to claim 1, wherein an HLB value of nonionic surfactant (D) is 12 to 20.

8. The coolant composition according to claim 1, wherein a content of water (B) is 45 to 75 parts by mass per 100 parts by mass of the coolant composition.

9. The coolant composition according to claim 1, wherein an electrical conductivity is 10 μS/cm or less.

10. A method for producing the coolant composition according to claim 1, comprising the step of:
determining the content ratio X (mol %) in the resulting coolant composition by measuring a freezing point of a solution containing components (A), (B), and (C) when the content ratio X (mol %) of component (C) to the sum of component (A) and component (C) is changed with the mass ratio of component (B) to the solution kept constant and finding a range of X wherein the above freezing point is equal to or lower than the freezing point of the solution at X=0 and equal to or lower than the freezing point of the solution at X=100.
